(19) United States
(12) Patent Application Publication
(10) Pub. No.: US 2026/0050314 A1
(43) Pub. Date: Feb. 19, 2026

(54) Digital Management of Power Supply Unit(s) in Network Devices

(71) Applicant: Cisco Technology, Inc., San Jose, CA (US)

(72) Inventors: Eric A. Voit, Bethesda, MD (US); Joel Richard Goergen, Soulsbyville, CA (US); Beth Kochuparambil, Morgan Hill, CA (US); River Lin, San Jose, CA (US); Zhiyuan Yao, AMSTERDAM (NL); Kami Hurst, Sonora, CA (US); Hrishikesh Pawar, BANGALORE (IN); Raghav Narasimhan, San Jose, CA (US); Emanuele Croci, FELTHAM (GB); Shobhana R. Punjabi, San Jose, CA (US); Ruqi Li, San Jose, CA (US)

(21) Appl. No.: 18/809,156

(22) Filed: Aug. 19, 2024

(51) Int. Cl. G06F 1/30

(52) U.S. Cl. CPC G06F 1/305

(57) ABSTRACT

Devices, systems, methods, and processes for operating a plurality of power supplies of a network device using cold redundancy are described herein. Traditionally, redundant power supplies are operated in parallel with primary power supplies, thus making power supply system less efficient. To address these issues, the present disclosure describes a digital mechanism of cold redundancy to manage the activity states of redundant power supplies. Each power supply is connected by a communication line configured to carry operational signals at a low frequency. In response to surge in load demand, a primary power supply may transmit high frequency cold redundancy signals to one or more redundant power supplies. The cold redundancy signals may be transmitted as superimposed signal over the communication line. At the receiving end, the superimposed signal is passed through a high-pass filter and a low-pass filter to segregate the cold redundancy signals and the communication line operational signals.

The present disclosure relates to network devices. More particularly, the present disclosure relates to managing primary and secondary power supplies of the network devices.

### BACKGROUND

Networking equipment (for example, router, switches, hubs, servers, firewalls, etc.) typically require reliable and uninterrupted power supply for their operation. To address potential power issues such as voltage fluctuations and power instability, network device architectures are often provided with redundant power supplies. Such redundancy may ensure continuous service and minimized downtime due to power-related problems.

Various examples of redundant power supply configurations include an N+1 configuration, an N+N configuration, or an N+M configuration. In the N+1 configuration, there are ‘N’ primary power supplies and one redundant power supply to take over if any primary supply fails. In the N+N configuration, there are ‘N’ primary power supplies and an equal number of redundant power supplies. In the N+M configuration, there are ‘N’ primary power supplies and ‘M’ redundant power supplies, where M can be any number needed to meet specific reliability requirements.

Typically, in a hot redundancy setup, redundant power supplies operate in parallel with the primary power supplies. Since load is shared among the primary and redundant power supplies, keeping all power supplies active simultaneously can result in inefficient operation. For example, each power supply, whether primary or redundant, may end up operating below its optimal efficiency range. As a result, the overall energy efficiency of the system may decrease, leading to wasted energy and decreased overall system performance.

### SUMMARY OF THE DISCLOSURE

Systems and methods for managing primary and secondary power supplies of the network devices in accordance with embodiments of the disclosure are described herein. In some embodiments, a power supply includes a processor, a communication line communicatively coupled to a plurality of redundant power supplies, a plurality of components configured to provide power to a device, a memory including cold redundancy logic configured to direct the power supply to gather a plurality of input factors, generate a ranking for each of the plurality of redundant power supplies, assign the ranking to each of the plurality of redundant power supplies, and transmit a change in activity state to at least one of the plurality of redundant power supplies via the communication line.

In some embodiments, the plurality of input factors includes attribute data associated with the plurality of redundant power supplies.

In some embodiments, the attribute data includes at least one of a power factor, phase, efficiency, or a current load.

In some embodiments, the ranking is generated based on the plurality of input factors.

In some embodiments, the ranking is configured to associate a more efficient power supply with a higher ranking.

In some embodiments, the ranking is assigned via the communication line.

In some embodiments, the communication line is utilized for load balancing between the power supply and the plurality of redundant power supplies.

In some embodiments, the communication line is an I-share line.

In some embodiments, prior to transmission, the cold redundancy logic is further configured to monitor the device.

In some embodiments, prior to transmission, the cold redundancy logic is further configured to determine that a change in activity state is needed based on the monitoring.

In some embodiments, prior to transmission, the cold redundancy logic is further configured to format the change in activity state.

In some embodiments, the communication line is utilized to transmit a lower-frequency signal between the power supply and the plurality of redundant power supplies.

In some embodiments, the formatting includes generating a higher-frequency signal compared to the lower-frequency signal, such that the higher-frequency signal can be received by the plurality of redundant power supplies through a high-pass filter applied to the communication line.

In some embodiments, the activity state includes an active state.

In some embodiments, the activity state includes a sleep state.

In some embodiments, a cold redundancy logic is configured to direct the power supply to receive a ranking from one of the plurality of additional power supplies, modify an activity state based on the ranking, monitor a signal received via the communication line, receive a change in activity state signal, change a current activity state of the power supply.

In some embodiments, the ranking includes configuration data.

In some embodiments, the change in activity state signal is received via the communication line.

In some embodiments, a high-pass filter is applied to the communication line for receiving the change in activity state signal.

In some embodiments, a method of managing power supplies includes gathering a plurality of input factors associated with one or more redundant power supplies, generating a ranking for each of the one or more redundant power supplies, assigning the ranking to each of the one or more redundant power supplies via a communication line coupled to each of the one or more redundant power supplies, and transmitting a change in activity state to at least one of the one or more redundant power supplies via the communication line.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual diagram of a network device including multiple power supplies in accordance with various embodiments of the disclosure;

FIG. 2 is a conceptual diagram of a network device including multiple PSUs connected with each other via a communication line in accordance with various embodiments of the disclosure;

FIG. 3 is a conceptual illustration of a high-pass filter and a low-pass filter used for superimposed cold redundancy management in accordance with various embodiments of the disclosure;

FIG. 4 is a graphical illustration depicting a change in activity state of PSUs in accordance with various embodiments of the disclosure;

FIG. 5 is a conceptual illustration depicting a state diagram for negotiating primary and secondary PSUs in accordance with various embodiments of the disclosure;

FIG. 6 is a conceptual illustration 600 depicting a cold redundancy renegotiation state machine in accordance with various embodiments of the disclosure;

FIG. 7 is a flowchart showing a process of ranking a plurality of PSUs in accordance with various embodiments of the disclosure;

FIG. 8 is a flowchart showing a process of modifying an activity state of one or more power supplies in accordance with various embodiments of the disclosure;

FIG. 9 is a flowchart showing a process of transmitting an activity state signal to one or more power supplies in accordance with various embodiments of the disclosure;

FIG. 10 is a flowchart showing a process of modifying an activity state of one or more power supplies in accordance with various embodiments of the disclosure;

FIG. 11 is a conceptual network diagram of various environments that a networking logic may operate on a plurality of network devices in accordance with various embodiments of the disclosure; and

FIG. 12 is a conceptual block diagram for one or more devices capable of executing components and logic for implementing the functionality and embodiments in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that provide a digital method of communication between a plurality of power supplies of a network device in a cold redundancy setup. Network devices (for example, routers, servers, switches, hubs, firewalls, or the like) often include power supply units (interchangeably referred to as “power supplies” or “PSUs”) that provide power to internal components of the network devices. For example, the PSUs can provide power to processors, memory, networking interfaces, and other electronic components of a network device. Generally, networking equipment require reliable and uninterrupted power supply for their operation. To address potential power issues, network device architectures are often provided with redundant (interchangeably referred to as “secondary”) PSUs. Examples of redundant power supply configurations include an N+1 configuration, an N+N configuration, or an N+M configuration. In the N+1 configuration, there are ‘N’ primary PSUs and one redundant PSU to take over if any primary PSU fails. In the N+N configuration, there are ‘N’ primary PSUs and an equal number of redundant PSUs. In the N+M configuration, there are ‘N’ primary PSUs and ‘M’ redundant PSUs.

Typically, the plurality of power supplies may operate using either a hot redundancy setup or a cold redundancy setup. In hot redundancy setup, both the primary and redundant PSUs are kept active simultaneously. Thus, if any primary PSU fails, the redundant PSU takes over and supplies power to the load seamlessly, for example, with no interruption. Since the load is shared among active PSUs, keeping the primary and redundant PSUs active simultaneously can result in inefficient operation, and each PSU may end up operating below its optimal efficiency range, Thus, leading to wasted energy and decreased overall system performance.

In cold redundancy setup, the redundant PSUs operate in a standby state (e.g., a sleep state or a low power state) while the primary PSUs operate in the active state. In a conventional cold redundancy setup, a central system software determines which PSU will operate as the primary PSU and which will serve as the redundant backup. Such central system software can be prone to glitches or bugs, which can lead to decision-making delays, frequent maintenance requirements, and compatibility issues with both hardware and software. Moreover, the central system software may determine the primary and backup assignments based on historical power usage data of the PSUs, overlooking phase balancing considerations required for even load distribution across the PSUs. This oversight can result in inefficient performance. In view of the issues discussed herein, the present disclosure describes a method of digital communication for managing cold redundancy between the plurality of PSUs of a network device. The digital communication between the plurality of PSUs may result in faster system response while improving efficiency of the cold redundancy setup.

In many embodiments, a network device (for example, routers, switches, hubs, servers, or the like) may be equipped with a plurality of PSUs connected to a system board. The plurality of PSUs may communicate with each other via a communication line. More specifically, the communication line may be an I-share line, also known as a current share line, share bus, or ISHARE signal. The I-share line may refer to a dedicated connection between parallel PSUs that enables active current sharing and balanced load distribution among the PSUs. Using the I-share line, each of the PSUs can monitor and control their individual output currents to achieve load balancing. Each power supply can sense its output current and can compare it to the desired current value as indicated on the I-share line. The power supply can then adjust its respective output voltage to increase or decrease corresponding share of the load current. Thus, this active feedback control can be used to ensure even distribution of the load across all the power supplies.

In a number of embodiments, the present disclosure may describe the utilize of the I-share line to negotiate the role of each of the PSUs operating in the network device. In various embodiments, a network device may include two or more PSUs. The two or more PSUs may negotiate among themselves to determine which one of the two or more PSUs may operate as a primary PSU, while the remaining PSUs may operate as redundant PSUs (or back-up PSUs). In several embodiments, the network device may be pre-configured with a primary PSU and a plurality of other PSUs configured as redundant PSUs. The primary PSU may be selected based on operational parameters such as a power factor, an efficiency curve, a quality of service, placement of a PSU on the system board, or other such parameters associated with the two or more PSUs. All these parameters thus may be used in selection of the best performing PSU as the primary PSU.

In a variety of embodiments, the primary PSU may gather a plurality of input factors related to the redundant PSUs. The plurality of input factors may include attribute data (for example, power factor, efficiency, a quality of service, phase, current load or other such parameters) associated with the redundant PSUs. The primary PSU may also consider the placement of the redundant PSU on the system board as a factor, as a PSU placed farther down the line on a system board would suffer greater resistance loss along the circuit path. In more embodiments, the primary PSU may generate a ranking for each of the plurality of redundant power supplies based on the gathered factors. The primary PSU may further assign the ranking to each of the plurality of redundant power supplies, such as a first secondary, a second secondary, or the like. In several more embodiments, a controller may assign one of the two or more PSUs as the primary PSU based on the plurality of input factors.

In several additional embodiments, the primary PSU may transmit activity state signals to the redundant PSUs, such as active, standby, sleep, shut-off, or the like. In many further embodiments, the activity state signals may be transmitted by superimposing the activity state signals on the I-share line. The redundant PSUs may be secondary PSUs operating in a standby mode (e.g., a sleep state) unless they receive an activity state signal to change the activity from the primary PSU on the I-share line. Thus, the present disclosure provides control to the primary PSU to operate the redundant PSUs based on various requirements.

In additional embodiments, the primary PSU may transmit a change in activity state to at least one of the plurality of redundant power supplies via the I-share line. The primary PSU may determine an increase in load demand on the network device via the I-share line. For example, the primary PSU may determine that a peripheral device such as an Internet Protocol (IP) phone has started drawing power from the network device, thus resulting in an increased load demand. In an example scenario, the primary PSU, based on the assigned ranking to the redundant PSUs, may transmit an activity state signal, superimposed on the I-share line, to the first secondary PSU to change its activity state from a sleep state to an active state. Since typically a PSU operates at its optimal efficiency at around 50-60% of load demand, in order to operate at optimal efficiency, the primary PSU can transmit the activity state signal to the first secondary PSU to change its activity state. In an example scenario, the activity state signal may be referred to as cold redundancy signal.

In further embodiments, the primary PSU may transmit the cold redundancy signal to the first secondary PSU via the communication line. The cold redundancy signal may be superimposed on the communication line or the I-share line. In still more embodiments, the cold redundancy signal may be a higher frequency signal configured to be transferred over the I-share line. More specifically, the cold redundancy signals may lie within the range >100 Hz and <9.5 kHz. The high frequency cold redundancy signal may not interfere with low frequency I-share communications signal used for sharing active current control, load balancing information, or the like between the plurality of PSUs. In still further embodiments, the superimposed cold redundancy signal and the I-share signal at the receive end of a corresponding PSU may pass through a high pass filter and a low pass filter to separate the I-share signal and the cold redundancy signal. The high frequency cold redundancy signal would pass through the high pass filter, and the I-share signal would pass through the low pass filter.

In still additional embodiments, the primary PSU may determine the order in which the redundant PSUs may operate to support the load demand. In yet more embodiments, the primary PSU may transmit the change in activity state to one or more redundant power supplies. The primary PSU may transmit the change in activity state in the form of a voltage level. Each of the plurality of PSUs may be configured to operate at different threshold voltage levels. For example, the primary PSU may operate at an activation threshold voltage level of 3V. Similarly, the first secondary PSU may operate at an activation threshold voltage level of 2.3V. Each of the plurality of PSUs may be configured to change their respective state from a sleep state to an active state at or below the activation threshold voltage level. Therefore, using a superimposed cold redundancy signal over the I-share signal provides an efficient cold redundancy mechanism. Further, the present disclosure may enable compatibility with existing systems in such a way that only the PSU units need to be replaced with an updated PSU and an update in the software. Therefore, the present disclosure provides a backward compatibility for the existing network devices having I-share line for communications.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for utilize by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

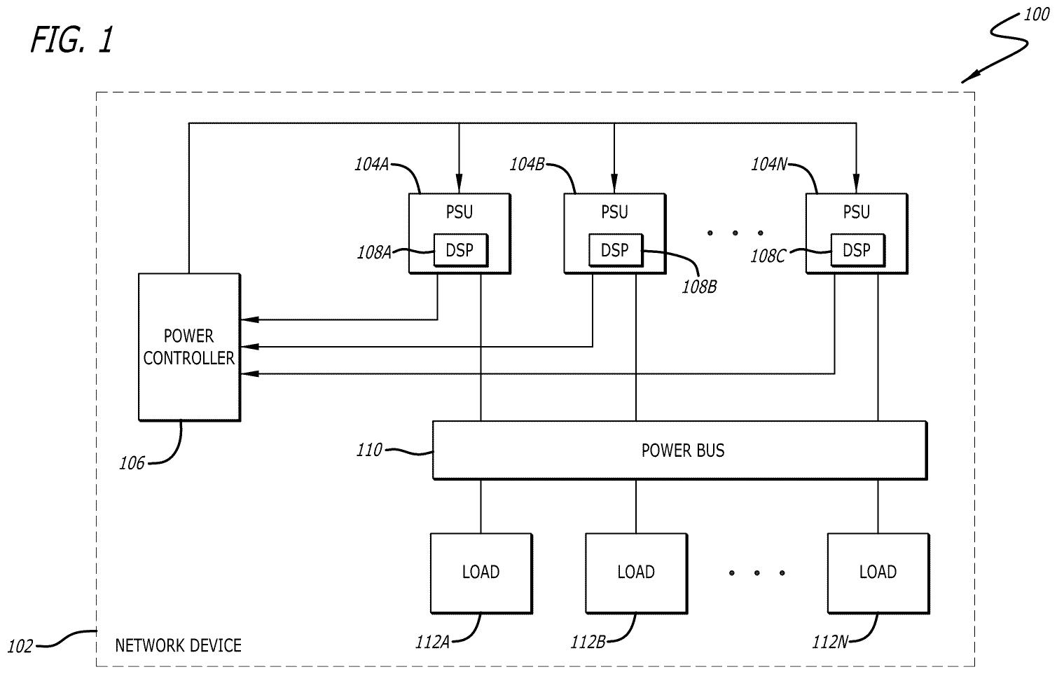

Referring to FIG. 1, a conceptual diagram 100 of a network device including multiple power supplies in accordance with various embodiments of the disclosure is shown. In many embodiments, the conceptual diagram 100 illustrates a network device 102 having a plurality of power supplies (interchangeably referred to as power supply units “PSUs”), for example, PSUs 104A, 104B, . . . , 104N. The network device 102 may refer to any networking equipment such as a router, a switch, an access point, a server, a firewall, or the like. In a variety of embodiments, at least one of the PSUs 104A-104N may be a primary PSU, and remaining PSUs can serve as secondary PSUs to provide redundancy if the primary PSU fails or is overloaded. The PSUs 104A-104N may be configured to supply power to various internal components of the network device 102, such as central processor, memory, network interface cards, cooling systems, Light Emitting Diode (LED) indicators, display panels, control and monitoring circuits, peripherals, or the like. All such internal components of the network device 102 drawing power from the PSUs 104A-104N may be referred to as load (depicted by loads 112A, 112B, . . . , 112N in the conceptual diagram 100).

In more embodiments, each of the PSUs 104A-104N may be connected to a power controller 106. The power controller 106 may be responsible for monitoring and controlling the PSUs 104A-104N. More specifically, the power controller 106 may provide load balancing among multiple PSUs 104A-104N based on load demand and/or dynamically adjusting the load distribution in real-time based on changing power demands of the loads 112A-112N. The power controller 106 may also provide redundancy management by monitoring the status of each PSU 104A-104N and can switch the load to at least one of the secondary PSUs if the primary PSU fails. The power controller 106 may also provide continuous monitoring of voltage, current, temperature, charge level, or other parameters of each PSU 104A-104N, thereby providing real-time data for system management. In still further embodiments, the power controller 106 may be an ASIC (Application-Specific Integrated Circuit) that can be specifically customized to provide optimized solutions for power management.

In yet more embodiments, each of the PSUs 104A-104N may include a digital signal processor (DSP) 108A, 108B, . . . , 108N. Each of the DSPs 108A-108N (e.g., a logic circuit) may be configured to provide voltage regulation, current regulation, dynamic power regulation, real-time monitoring of various parameters, or the like. The DSPs 108A-108N may be further configured to read a voltage level or current level on a communication line, also referred to as I-share line, and adjust each of the respective PSUs 104A-104N output voltage or current level for load balancing. In still yet more embodiments, each of the DSPs 108A-108N may be configured to store a mapping associating different voltage levels for activity threshold of different PSUs 104A-104N. For example, in the mapping, ‘3V’ may be associated with the primary PSU activity threshold and ‘2.3V’ may be associated with a first secondary PSU activity threshold. Thus, based on a voltage level present on the I-share line, the first secondary PSU may determine to change its activity state from a sleep state to an active state.

In still additional embodiments, each of the PSUs 104A-104N may be connected to a power bus 110. The power bus 110 may provide a centralized point for distributing power from the PSUs 104A-104N to multiple devices, internal components, or circuits within the network device 102. The power bus 110 may reduce the complexity of wiring by consolidating power lines into a single bus, thereby making the design and maintenance of power distribution system more organized.

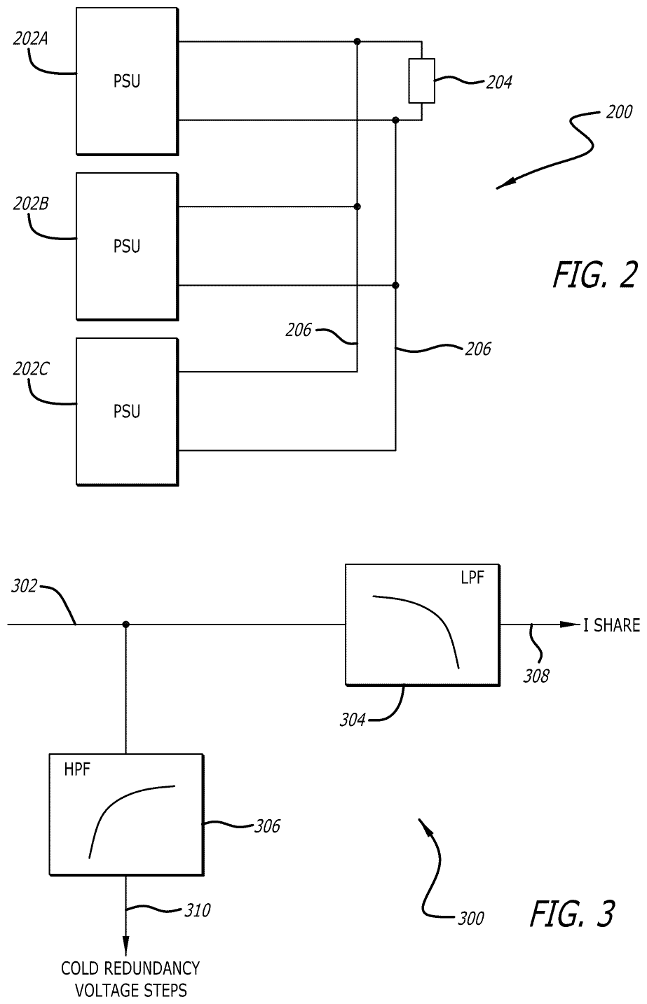

Although a specific embodiment for a network device including multiple power supplies suitable for carrying out the various steps, processes, methods, and operations described herein is discussed with respect to FIG. 1, any of a variety of systems and/or processes may be utilized in accordance with embodiments of the disclosure. In yet more embodiments, the power controller 106 may be a digital controller. The power controller 106 may utilize analog feedback signals, such as voltage or current feedback, from the PSUs 104A-104N for power management. The power controller 106 may then monitor and control various parameters of the PSUs 104A-104N using sensors and ADCs (Analog-to-Digital Converters). The elements depicted in FIG. 1 may also be interchangeable with other elements of FIGS. 2-12 as required to realize a particularly desired embodiment.

Referring to FIG. 2, a conceptual diagram of a network device 200 including multiple PSUs connected with each other via a communication line in accordance with various embodiments of the disclosure is shown. The embodiments shown in FIG. 2 illustrates the network device 200 having a plurality of PSUs, for example, PSUs 202A, 202B, 202C. The network device 200 may refer to any networking equipment such as a router, a switch, an access point, a server, a firewall, or the like. In a variety of embodiments, at least one of the PSUs 202A-202C may be a primary PSU, and remaining PSUs can serve as secondary PSUs to provide redundancy if the primary PSU fails or is overloaded. In a number of embodiments, the PSUs 202A-202C may be connected in a parallel configuration and supplying power to a load 204.

In several embodiments, the PSUs 202A-202C may be connected to each other via a communication line 206. In a particular scenario, the communication line 206 may be an I-share line, also known as a current share line, or I-share signal. The I-share line may be utilized to transmit a common current sharing signal that may represent the total current demand by the load 204. The I-share line may enable the PSUs 202A-202C for active current sharing and balanced load distribution between the PSUs 202A-202C. The I-share signal may be an analog signal and operate at a low frequency to avoid interference with other high-frequency signals present in the PSUs 202A-202C, such as high frequency switching noise.

In more embodiments, each of the PSUs 202A-202C may have a built-in current sensing circuitry (for example, DSPs) that can measure an output current the corresponding PSU is supplying to the load 204. Various other circuits can substitute for a current sensing circuitry depending on the application and requirements. One such alternative is the operational amplifier (op-amp) configured as a voltage follower with a high gain, which can perform similar comparison tasks by amplifying the difference between two input voltages. Another substitute may be a differential amplifier circuit, which amplifies the difference between two input signals and can be used in precision applications where a comparator's speed and simplicity are less critical. For specific applications like zero-crossing detection or signal threshold monitoring, a microcontroller with integrated comparators can provide a more compact and programmable solution. Additionally, logic gates configured to mimic comparator behavior can serve as an alternative in digital circuits, though this approach might be more complex.

Based on the measured output current, in several embodiments, each PSU PSUs 202A-202C may generate a voltage signal proportional to corresponding output current. This signal is referred to as the I-share signal. These I-share signals from all the PSUs 202A-202C may be connected together through a common I-share line (e.g., the communication line 206). The common I-share signal may represent a combined signal that is an average or total current being supplied by all the PSUs 202A-202C. Each of the PSUs 202A-202C may read the combined I-share signal on the common line (e.g., the communication line 206) and compare the read signal with respective output current signal. In still more embodiments, if a PSU (e.g., any of the PSUs 202A-202C) determines that the PSU may be supplying less current than what the I-share signal indicates, the PSU may increase corresponding output. Conversely, if the PSU determines that the PSU is supplying more current, the PSU may decrease corresponding output. Such feedback loop may ensure balanced current sharing across the load 204.

Although a specific embodiment for a network device including multiple PSUs connected with each other via a communication line suitable for carrying out the various steps, processes, methods, and operations described herein is discussed with respect to FIG. 2, any of a variety of systems and/or processes may be utilized in accordance with embodiments of the disclosure. In still additional embodiments, the I-share signal may be a digital connection between the PSUs 202A-202C and can use various communication protocols such as Power Management Bus (PMBus), Inter-Integrated Circuit (I²C), or the like to share current information and manage load balancing among PSUs 202A-202C. The elements depicted in FIG. 2 may also be interchangeable with other elements of FIGS. 1 and 3-12 as required to realize a particularly desired embodiment.

Referring to FIG. 3, a conceptual illustration 300 of a high-pass filter and a low-pass filter used for superimposed cold redundancy management in accordance with various embodiments of the disclosure is shown. In many embodiments, the conceptual illustration 300 describes a superimposed I-share signal 302. The superimposed I-share signal 302 may be shared between a plurality of PSUs in a network device. The I-share line may enable the plurality of PSUs for active current sharing and balanced load distribution. In a variety of embodiments, the I-share signal 302 may be a superimposed signal carrying a cold redundancy signal 310 as well as an I-share signal 308. In additional embodiments, the cold redundancy signal 310 may refer to signals indicating specific voltage levels corresponding to activity state of each of the plurality of PSUs. The I-share signal 308 may refer to a common signal corresponding to the total current being supplied by the plurality of the PSUs in the system. In further embodiments, the cold redundancy signal 310 may be at a comparatively higher frequency than the I-share signal 308. More specifically, the cold redundancy signal 310 may operate between the frequency range of >100 Hz and <9.5 kHz.

In a number of embodiments, the conceptual illustration 300 may depict a scenario at the receiving end of the superimposed I-share signal 302. The superimposed I-share signal 302 before being received by a PSU may be divided into a high-pass component and a low-pass component. For this, the superimposed I-share signal 302 may be passed through a high-pass filter 306 and a low-pass filter 304. The high-pass filter 306 may refer to an electronic circuit that allows signals with frequencies above a certain cutoff frequency to pass through unattenuated, while attenuating or blocking signals with frequencies below the cutoff frequency. Similarly, the low-pass filter 304 may also refer to an electronic circuit that allows signals with frequencies below a specified cutoff frequency to pass through unattenuated, while attenuating or blocking signals with frequencies above the cutoff frequency.

In a variety of embodiments, the superimposed I-share signal 302 when passed through the high-pass filter 306 may result in the cold redundancy signal 310 and when passed through the low-pass filter 304 may result in the I-share signal 308. The I-share signal 308 may operate at a low frequency to avoid interference with the high-frequency switching noise present in the PSUs. Thus, the cold redundancy signal 310 may be received by a corresponding PSU from among the plurality of PSUs.

In further embodiments, if a primary PSU of the network device may determine that an additional PSU is required to support the load demand, the primary PSU may transmit the cold redundancy signal 310 as the superimposed I-share signal 302. In more embodiments, the cold redundancy signal 310 may refer to activation threshold voltage level for the corresponding PSU. For example, the cold redundancy signal 310 may correspond to a voltage level of ‘2.3V’ which may be the activation threshold for a first secondary PSU in the network device. In additional embodiments, the PSU receiving the cold redundancy signal 310 may change its activity state from a sleep state to an active state. Other secondary (or redundant) PSUs that have a lower activation threshold may also receive the cold redundancy signal 310 but may not change their activity state.

Although a specific embodiment for a high-pass filter and a low-pass filter utilized for superimposed cold redundancy management suitable for carrying out the various steps, processes, methods, and operations described herein is discussed with respect to FIG. 3, any of a variety of systems and/or processes may be utilized in accordance with embodiments of the disclosure. In further embodiments, a PSU controller may change the cutoff frequency of the high-pass filter 306 as per the requirement. The elements depicted in FIG. 3 may also be interchangeable with other elements of FIGS. 1-2 and 4-12 as required to realize a particularly desired embodiment.

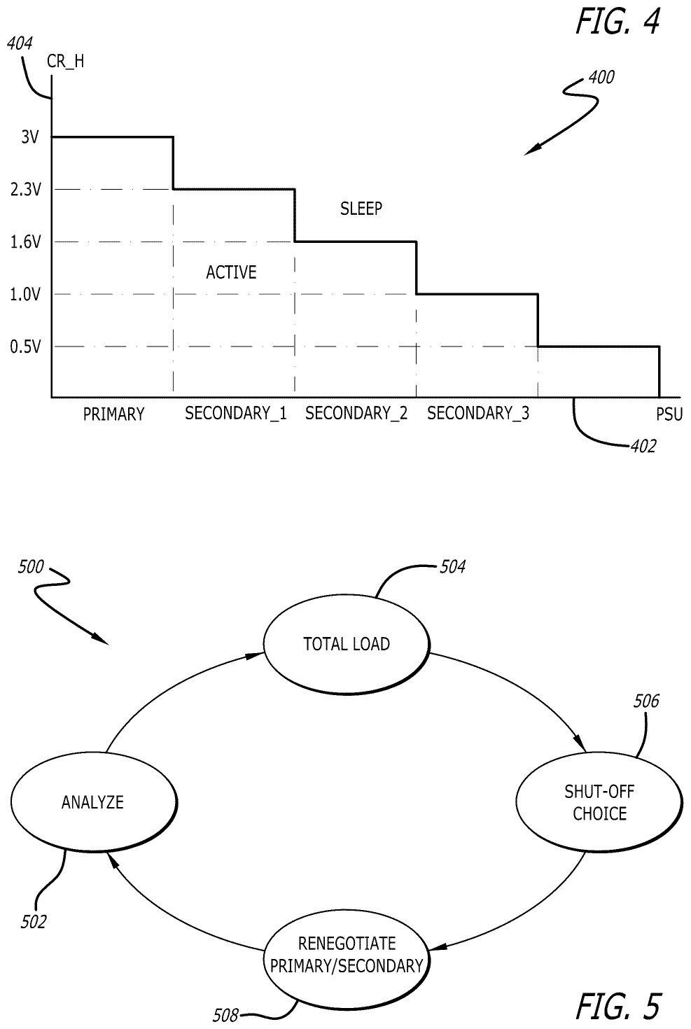

Referring to FIG. 4, a graphical illustration 400 depicting a change in activity state of PSUs in accordance with various embodiments of the disclosure is shown. In many embodiments, a graph 400, depicted in FIG. 4, shows different voltage levels (indicated as CR_H across Y-axis 404) at which different PSUs (shown across X-axis 402) change their activity state from a sleep state to an active state. The activity state may refer to the operational state of a PSU. For example, a PSU in the active state may supply required power for a load demand, whereas in the sleep state, the PSU stays in a standby mode. In standby mode, the PSU may operate in a low-power state with minimal energy consumption and without powering any load.

In a number of embodiments, a primary PSU may transmit a command to one of the redundant PSUs (interchangeably referred to as secondary PSUs) to change its activity state. The primary PSU may determine an increase in the load demand and may select a PSU ranked as a first secondary PSU (indicated as Secondary_1) from among the redundant PSUs. Each of the redundant PSUs may be configured to operate at different activation threshold voltage levels. The activation threshold voltage level may refer to the voltage below which a PSU may change its activity state from sleep to active. For example, the first secondary PSU may be configured to have an activation threshold voltage level as ‘2.3V’. Similarly, the second secondary PSU (indicated as Secondary_2) may be configured to have an activation threshold voltage level as ‘1.6V’. Similarly, for other redundant PSUs, respective activation threshold voltage levels may be utilized to switch the activity state. In an example scenario, in order to change the activity state of the first secondary PSU, the primary PSU may need to transmit a cold redundancy signal corresponding to the activation threshold voltage level of the first secondary PSU. If the redundant PSUs receive a cold redundancy signal corresponding to a voltage level of ‘2.0V’, the first secondary PSU may change their activity state from sleep to active as the cold redundancy signal meets the activity threshold voltage level for the first secondary PSU. All the remaining redundant PSUs may continue to operate in a sleep state as the activation threshold voltage levels for the corresponding PSUs are not met. A person of ordinary skill in the art would appreciate that the voltage levels depicted in FIG. 4 are for example purposes and should not be construed to limit the scope of the disclosure.

Although a specific embodiment depicting a change in activity state of PSUs suitable for carrying out the various steps, processes, methods, and operations described herein is discussed with respect to FIG. 4, any of a variety of systems and/or processes may be utilized in accordance with embodiments of the disclosure. In still more embodiments, all the PSUs may operate in an active state if a cold redundancy signal is provided at an activation threshold voltage level of the least optimal secondary PSU, for example, at 0.5V. The elements depicted in FIG. 4 may also be interchangeable with other elements of FIGS. 1-3 and 5-12 as required to realize a particularly desired embodiment.

Referring to FIG. 5, a conceptual illustration 500 depicting a state diagram for negotiating primary and secondary PSUs in accordance with various embodiments of the disclosure is shown. In many embodiments, at 502, the primary PSU of a network device may be configured to determine a ranking order for a plurality of redundant PSUs based on gathered input factors for corresponding redundant PSUs. The input factors may include attribute data such as a power factor, phase, efficiency, current load, or other such data associated with each of the plurality of redundant PSUs. Thus, the primary PSU may analyze all these gathered input factors to determine the ranking order for the plurality of redundant PSUs, such a first secondary PSU, a second secondary PSU, or so on. For example, the primary PSU may determine that a redundant PSU is placed at a greater distance from the load and has a lower efficiency parameter. Thus, the primary PSU may rank this particular redundant PSU lower in the order of ranking of the plurality of redundant PSUs.

In a number of embodiments, at 504, the primary PSU may determine a total load that requires power supply. The primary PSU may determine whether the total load can be satisfied by the primary PSU or whether other redundant power supplies may also be required. The primary PSU may operate at peak efficiency at 50-60% of the total load. As the load demand increases, the primary PSU may need to transmit an activation command to one of the plurality of redundant PSUs to satisfy the increased load demand. In a variety of embodiments, the primary PSU may transmit the activity state change command based on the order of ranking of the plurality of redundant PSUs. In more embodiments, the primary PSU may check the efficiency curve of each of the plurality of redundant PSUs to determine the most optimal redundant PSU to supply power as a secondary PSU.

In additional embodiments, at 506, the primary PSU may process a shut-off choice command. The primary PSU may transmit an active state or a sleep state signal to a selected secondary PSU from the plurality of redundant PSUs. For example, if the primary PSU determines that the load demand can be satisfied using power supply from the primary PSU and the first secondary PSU, the primary PSU may transmit a signal corresponding to an activation threshold voltage level for the first secondary PSU to change its activity state. Similarly, if the load demand decreases and the primary PSU determines that a secondary PSU was running in the active state, the primary PSU may transmit a signal corresponding to the sleep state for the secondary PSU. Therefore, the shut-off choice commands may include a plurality of activity states that can be selected by the primary PSU for driving the activity state of one or more secondary PSUs. In further embodiments, the primary PSU may transmit different signals such as ACTIVE_Standby, ACTIVE_Supplying power, SLEEP, or the like to the plurality of redundant PSUs based on the determined total load. In ACTIVE_Standby state, a PSU may operate at a reduced power level compared to its ACTIVE_Supplying power state but may still consume more power than the SLEEP state. The PSU in ACTIVE_Standby state may remain powered on and maintain a level of readiness to quickly ramp up to full power when needed. In SLEEP state, the PSU may significantly reduce its power output to the minimum necessary to keep required circuits alive. The PSU in SLEEP state may typically require more time to become fully operational compared to ACTIVE_Standby state. In the SLEEP state, the PSU aims to conserve as much energy as possible.

In still more embodiments, at 508, the PSUs of the network may renegotiate for the determination of a new primary PSU and a plurality of redundant PSUs. In an example scenario, the primary PSU may suffer a failure and thus, a new primary PSU may be required. In still further embodiments, the PSUs may store information regarding their corresponding efficiency parameters, quality factor, power factor, or the like. The PSUs may, therefore, communicate among themselves to negotiate which of the PSUs may function as a primary PSU and a new ranking for each of a plurality of new redundant PSUs. In still additional embodiments, a controller may be used to negotiate and provide an assignment to a PSU as a new primary PSU and a new ranking for each of a plurality of new redundant PSUs. The controller may be configured to store the attribute data for each of the PSUs of the network device.

Although a specific embodiment depicting a state diagram for negotiating primary and secondary PSUs suitable for carrying out the various steps, processes, methods, and operations described herein is discussed with respect to FIG. 5, any of a variety of systems and/or processes may be utilized in accordance with embodiments of the disclosure. In yet more embodiments, a software defined process may be used to assign the PSUs as a primary PSU and a ranking for each of the plurality of redundant power supplies as a first secondary, a second secondary, or the like. The software defined process may utilize the attribute data of each of the PSUs for the negotiation process. In case of a failure of the primary PSU, the software defined process may automatically assign the next PSU (for example, a first secondary PSU) in the order of ranking as the primary PSU. The elements depicted in FIG. 5 may also be interchangeable with other elements of FIGS. 1-4 and 6-12 as required to realize a particularly desired embodiment.

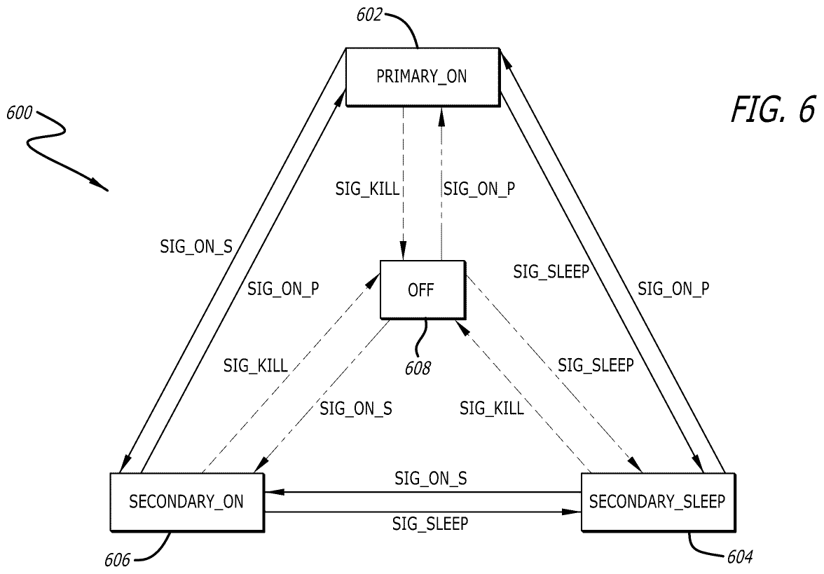

Referring to FIG. 6, a conceptual illustration 600 depicting a cold redundancy renegotiation state machine in accordance with various embodiments of the disclosure is shown. In many embodiments, a state machine, as depicted in FIG. 6, may include a primary PSU 602, a first secondary PSU 604, and a second secondary PSU 606. In a number of embodiments, the primary PSU 602 may operate in an active state (depicted as PRIMARY_ON). The primary PSU 602 may thus be configured to actively supply power to a load demand. The first secondary PSU 604 may operate in an active mode (depicted as SECONDARY_ON), whereas the second secondary PSU 606 may operate in a sleep mode (depicted as SECONDARY_SLEEP). For the sake of brevity, only three PSUs have been shown to depict an example scenario; however, more than three PSUs can operate in a network device without deviating from the scope of the disclosure.

In a variety of embodiments, all the PSUs of a network device may renegotiate after some time to select a new primary PSU and a plurality of secondary PSUs. The secondary PSUs thereafter may be ranked as a first secondary, a second secondary, or the like based on their respective attributes. More specifically, a PSU operating as a primary PSU may be assigned as a first secondary PSU after the renegotiation based on a determined load demand and the PSU's attributes.

In more embodiments, the primary PSU 602 may transmit a command (depicted as SIG_ON_S) to switch the activity state of the first secondary PSU 604, for example, to switch to an active state (depicted as SECONDARY_ON). Similarly, the primary PSU 602 may transmit a command (depicted as SIG_SLEEP) to switch the activity state of the second secondary PSU 606, for example, to switch to sleep state (depicted as SECONDARY_SLEEP). In additional embodiments, the first secondary PSU 604 may also transmit a command (depicted as SIG_ON_P) to the primary PSU 602 to switch the activity state of the primary PSU 602. For example, if due to overheat conditions, the primary PSU 602 may switch to the sleep state for a fixed period of time, the first secondary PSU 604 may thus transmit the command to switch the primary PSU 602 in the active state after the lapse of the fixed period of time. In a similar manner, the second secondary PSU 606 can transmit commands to or receive commands from the first secondary PSU 604 and the primary PSU 602.

In further embodiments, the primary PSU 602, the first secondary PSU 604, and the second secondary PSU 606 may be controlled by a central controller 608 (depicted as OFF). The central controller 608 may transmit commands to corresponding PSUs to switch their activity state based on the determined load demand. In still more embodiments, the central controller 608 may receive a command from each of the PSUs indicating that the corresponding PSU is turned off (depicted as SIG_KILL). In still more embodiments, the primary PSU 602, the first secondary PSU 604, and the second secondary PSU 606 may interchange their operations based on the determined load demand and the corresponding PSU attribute values.

Although a specific embodiment depicting a cold redundancy renegotiation state machine suitable for carrying out the various steps, processes, methods, and operations described herein is discussed with respect to FIG. 6, any of a variety of systems and/or processes may be utilized in accordance with embodiments of the disclosure. In still further embodiments, the renegotiation for the primary PSU 602, the first secondary PSU 604, and the second secondary PSU 606 may occur after a fixed time interval. The elements depicted in FIG. 6 may also be interchangeable with other elements of FIGS. 1-6 and 7-12 as required to realize a particularly desired embodiment.

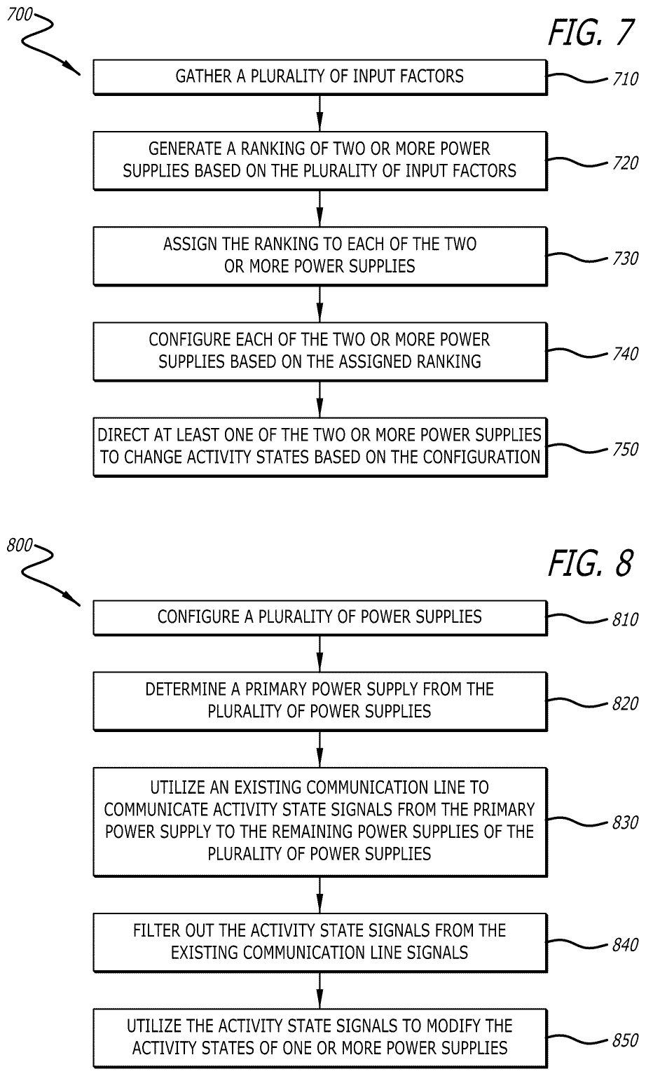

Referring to FIG. 7, a flowchart showing a process 700 of ranking a plurality of PSUs in accordance with various embodiments of the disclosure is shown. In many embodiments, the process 700 may gather a plurality of input factors (block 710). In a number of embodiments, the process 700 may configure a primary PSU of a network device to gather the plurality of factors of a plurality of redundant PSUs. The plurality of factors may refer to attribute data such as power factor, phase, efficiency, a current load, or the like of the plurality of redundant PSUs.

In a variety of embodiments, the process 700 may generate a ranking of two or more power supplies based on the plurality of factors (block 720). The process 700 may generate the ranking of the two or more power supplies from among the plurality of redundant PSUs. In more embodiments, the primary PSU may utilize a logic circuit (such as a DSP) to generate the ranking of the two or more power supplies based on the plurality of input factors.

In additional embodiments, the process 700 may assign the ranking to each of the two or more power supplies (block 730). The process 700 may provide an assignment to the two or more power supplies as a first secondary PSU, a second secondary PSU, and so on. In more embodiments, the ranking of the PSUs may determine the order in which the PSUs may be configured to supply power in case of an increase in load demand.

In further embodiments, the process 700 may configure each of the two or more power supplies based on the assigned ranking (block 740). The process 700 may configure each of the two or more power supplies with the corresponding activation threshold voltage levels. Each of the PSUs may be configured to operate at or below a certain voltage level referred to as the activation threshold voltage level. For example, for the primary PSU, the activation threshold voltage level may be ‘3V’, for the first secondary PSU as ‘2.3V’, the second secondary PSU ‘1.6V’, and so on. The activation threshold voltage level indicates that the corresponding PSU may become active upon receiving a voltage level either equal to or less than the activation threshold voltage level.

In still more embodiments, the process 700 may direct at least one of the two or more power supplies to change activity states based on the configuration (block 750). The process 700 may transmit a command to at least one of the two or more power supplies to change its activity state from a sleep state to an active state. For example, a primary PSU may determine an increase in the load demand, and thus, may direct the first secondary PSU to switch from a sleep state to an active state to satisfy the increased load demand.

Although a specific embodiment depicting a process 700 of ranking a plurality of PSUs suitable for carrying out the various steps, processes, methods, and operations described herein is discussed with respect to FIG. 7, any of a variety of systems and/or processes may be utilized in accordance with embodiments of the disclosure. In still additional embodiments, the process 700 may assign same rank to at least two PSUs from among the plurality of redundant PSUs based on their attribute values. The elements depicted in FIG. 7 may also be interchangeable with other elements of FIGS. 1-6 and 8-12 as required to realize a particularly desired embodiment.

Referring to FIG. 8, a flowchart showing a process 800 of modifying an activity state of one or more power supplies in accordance with various embodiments of the disclosure is shown. In many embodiments, the process 800 may configure a plurality of power supplies (block 810). The process 800 may set up the voltage and current settings for each of the plurality of power supplies. In a number of embodiments, the process 800 may configure the different activity states (such as active, standby, sleep, or the like) for the plurality of power supplies. The process 800 may also configure an activation threshold voltage level for each of the plurality of power supplies. The process 800 may also determine corresponding attribute data for each of the plurality of power supplies.

In a variety of embodiments, the process 800 may determine a primary power supply from the plurality of power supplies (block 820). The process 800 may determine the primary power supply based on the attribute data and the configuration parameters. The process 800 may select (or determine) the primary power supply as the one with higher efficiency value, higher power factor, and sometimes based on the placement of the power supply in the network device.

In more embodiments, the process 800 may utilize an existing communication line to communicate activity state signals from the primary power supply to the remaining power supplies of the plurality of power supplies (block 830). For example, the process 800 may utilize an I-share line (e.g., the existing communication line) to communicate the activity state signals from the primary power supply to the remaining power supplies of the plurality of power supplies. The process 800 may generate a superimposed signal by superimposing the activity state signals on the I-share line signals.

In further embodiments, the process 800 may filter out the activity state signals from the existing communication line signals (block 840). The activity state signals may be high-frequency signals, whereas the communication line signals may operate as low-frequency signals. The process 800 may, therefore, utilize a high-pass filter and a low-pass filter to separate out the two signals from the superimposed signal. For example, the process 800 may pass the superimposed signal through a high-pass filter to obtain the activity state signals and through a low-pass filter to obtain the communication line signals, such as an I-share signal.

In still more embodiments, the process 800 may utilize the activity state signals to modify the activity states of one or more power supplies (block 850). The process 800 may utilize the activity state signal to switch the activity state of one or more power supplies from a sleep state to an active state. In still further embodiments, the process 800 may transmit the activity state signals as a corresponding activation threshold voltage level.

Although a specific embodiment depicting modifying an activity state of one or more power supplies suitable for carrying out the various steps, processes, methods, and operations described herein is discussed with respect to FIG. 8, any of a variety of systems and/or processes may be utilized in accordance with embodiments of the disclosure. In still further embodiments, the process 800 may switch the activity state of one or more power supplies when the received voltage signal is above the activation threshold voltage level. The elements depicted in FIG. 8 may also be interchangeable with other elements of FIGS. 1-7 and 9-12 as required to realize a particularly desired embodiment.

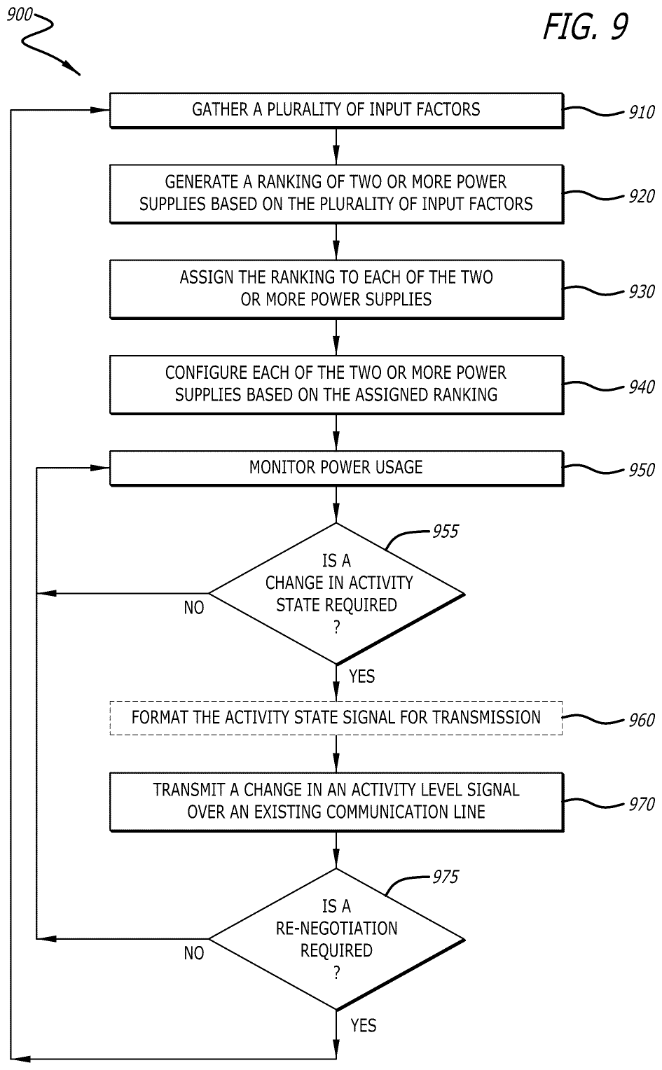

Referring F to FIG. 9, a flowchart showing a process 900 of transmitting an activity state signal to one or more power supplies in accordance with various embodiments of the disclosure is shown. In many embodiments, the process 900 may gather a plurality of input factors (block 910). In a number of embodiments, the process 900 may configure a primary PSU of a network device to gather the plurality of input factors of a plurality of redundant PSUs. The plurality of input factors may refer to attribute data such as power factor, phase, efficiency, a current load, or the like of the plurality of redundant PSUs.

In a variety of embodiments, the process 900 may generate a ranking of two or more power supplies based on the plurality of input factors (block 920). The process 900 may generate the ranking of the two or more power supplies from among the plurality of redundant PSUs. In more embodiments, the primary PSU may utilize a logic circuit (such as a DSP) to generate the ranking of the two or more power supplies based on the plurality of input factors.

In more embodiments, the process 900 may assign the ranking to each of the two or more power supplies (block 930). The process 900 may provide an assignment to the two or more power supplies as a first secondary PSU, a second secondary PSU, a third secondary PSU, and so on. In more embodiments, the ranking of the PSUs may determine the order in which the PSUs may be configured to supply power in case of an increase in load demand. In additional embodiments, the ranking may also indicate which of the two or more power supplies may operate as a new primary PSU in case of failure of the primary PSU.

In further embodiments, the process 900 may configure each of the two or more power supplies based on the assigned ranking (block 940). The process 900 may configure each of the two or more power supplies with the corresponding activation threshold voltage levels. Each of the PSUs may be configured to operate at or below a certain voltage level referred to as the activation threshold voltage level. The activation threshold voltage level indicates that the corresponding PSU may become active upon receiving a voltage level either equal to or less than the activation threshold voltage level.

In still more embodiments, the process 900 may monitor power usage (block 950). The process 900 may monitor the power usage of the network device. The primary and the two or more power supplies included in the network device may be configured to supply power to various internal components of the network device such as memory, control circuit, processors, other internal components, and sometimes to peripheral devices connected to the network device. The process 900 may, therefore, continuously monitor the power usage requirements of the network device. For example, when a peripheral device may be connected to the network device, the power usage requirement may increase.

In still further embodiments, the process 900 may detect if a change in activity state is required (block 955). The activity state may refer to a sleep state or an active state. The process 900 may determine the number of power supplies that may be required to satisfy a current load demand based on monitoring of the power usage. In an example scenario, the primary power supply may be sufficient to satisfy the load demand for a particular load value. However, as the load demand increases, the process 900 may determine that at least one secondary power supply may also be needed to satisfy the load demand. Thus, the process 900 may detect that a change in the activity state of the secondary power supply is required, from sleep state to active state.

In still additional embodiments, if the change in activity state is required, the process 900 may format the activity state signal for transmission (block 960). In yet more embodiments, the activity state signal may be modulated to a high-frequency signal. The activity state signal may be formatted according to the specific requirements of the system it interacts with or as per industry standards. The formatting can involve setting the voltage level, frequency, or protocol (e.g., I²C, SPI). In still yet more embodiments, the activity state signal may correspond to cold redundancy voltage level set for corresponding power supply. In many further embodiments, formatting of the activity state signal may be an optional step.

In many additional embodiments, the process 900 may transmit a change in an activity state signal over an existing communication line (block 970). The process 900 may superimpose the activity state signal over the communication line. In many further embodiments, the activity state signal may be a high-frequency signal, whereas signals being transmitted over the communication line may be low-frequency signals, so that the two signals do not interfere with each other. The process 900 may transmit the change in activity state signal to a secondary power supply to change its activity state, such as from a sleep state to an active state.

In still yet further embodiments, the process 900 may determine if a re-negotiation is required (block 975). The process 900 may re-negotiate for the determination of a new primary power supply and a plurality of secondary power supplies. In an example scenario, the primary power supply may suffer a failure and thus, a new primary power supply may be required to be selected. In still yet additional embodiments, the power supplies may store information regarding their corresponding efficiency parameters, quality factor, power factor, or the like. The power supplies may, therefore, communicate among themselves to negotiate which of the power supplies may function as a primary power supply and a new ranking for each of a plurality of new secondary power supplies.

In several embodiments, if the process 900 determines that a re-negotiation is required, the process 900 may gather a plurality of input factors (block 910). The process 900 may enable the power supplies to communicate the respective attribute data among themselves to re-negotiate a primary power supply and plurality of new secondary power supplies. However, if the process 900 determines that a re-negotiation is not required, the process 900 may continue to monitor the power usage (block 950). The process 900 may monitor the power usage in a periodic interval.

Although a specific embodiment depicting transmitting an activity state signal to one or more power supplies suitable for carrying out the various steps, processes, methods, and operations described herein is discussed with respect to FIG. 9, any of a variety of systems and/or processes may be utilized in accordance with embodiments of the disclosure. In several more embodiments, the process 900 may assign same rank to all the secondary power supplies, such that when the load demand increases, any one of the secondary power supplies can be used to satisfy the increased load demand. The elements depicted in FIG. 9 may also be interchangeable with other elements of FIGS. 1-8 and 10-12 as required to realize a particularly desired embodiment.

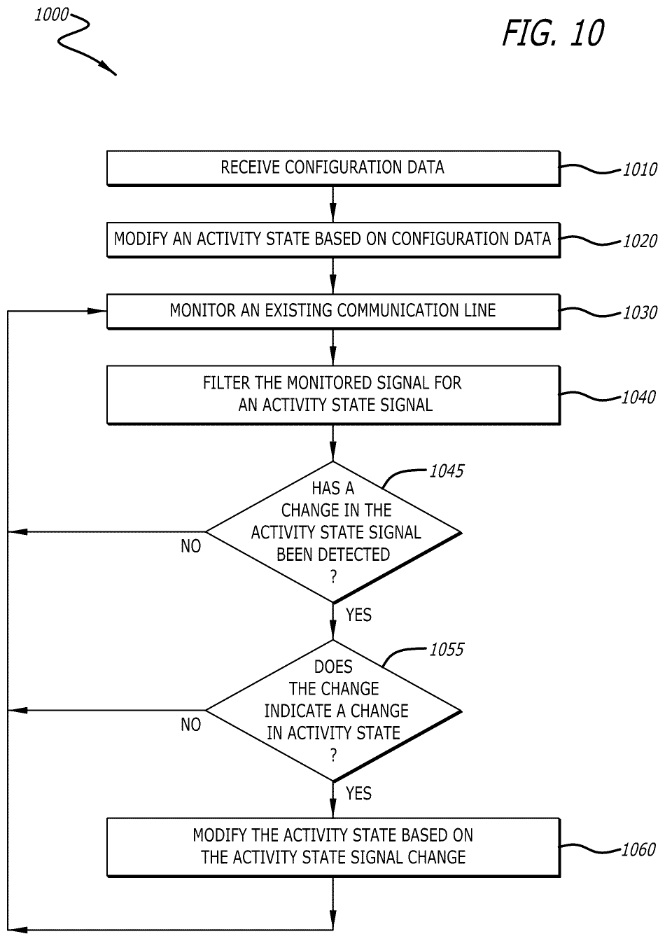

Referring to FIG. 10, a flowchart showing a process 1000 of modifying an activity state of one or more power supplies in accordance with various embodiments of the disclosure is shown. In many embodiments, the process 1000 may receive configuration data (block 1010). The process 1000 may configure a power supply to receive corresponding configuration data that may refer to an activation threshold voltage level. Each of a plurality of power supplies of a network device may be configured to operate at or below the corresponding activation threshold voltage level. The activation threshold voltage level indicates that the corresponding PSU may change its activity state to active upon receiving a voltage level either equal to or less than the activation threshold voltage level.

In a number of embodiments, the process 1000 may modify an activity state based on configuration data (block 1020). The process 1000 may determine the configuration data and may accordingly change the activity state of the power supply. In an example scenario, the configuration data of a first secondary power supply may indicate an activation threshold voltage level as ‘2.3V’. Thus, if a voltage level received by the first secondary power supply is ‘2.8V’, the process 1000 may change the activity state of the first secondary power supply to a sleep state.

In a variety of embodiments, the process 1000 may monitor an existing communication line (block 1030). The process 1000 may monitor the communication line used by the plurality of power supplies to communicate respective voltage levels, current levels, load balancing information, or the like. The process 1000 may monitor signals on the communication line for the information being transmitted. In additional embodiments, the communication line may carry a superimposed signal having a cold redundancy signal and the communication line signals. The cold redundancy signal may refer to signals indicating specific voltage levels corresponding to activity state of each of the plurality of power supplies. In further embodiments, the signals transmitted via the communication line may be low-frequency signals, whereas the cold redundancy signals superimposed on the communication line may be high-frequency signals.

In additional embodiments, the process 1000 may filter the monitored signal for an activity state signal (block 1040). The process 1000 may filter the superimposed signal being transmitted on the communication line. The process 1000 at the receiving end of the superimposed signal may utilize a high-pass filter to extract the cold redundancy signals and a low-pass filter to extract the communication line signals.

In still more embodiments, the process 1000 may determine if a change in the activity state signal has been detected (block 1045). The process 1000 may determine whether the cold redundancy signal indicates a change in the activity state for the corresponding power supply receiving the superimposed signal. The process 1000 may determine if the cold redundancy signal indicates a change in the voltage level being received at the corresponding power supply.

In still further embodiments, the process 1000 may determine if the change indicates a change in the activity state (block 1055). The process 1000 may determine if the cold redundancy signal indicates an activation threshold voltage level for the power supply. In an example scenario, the process 1000 may determine a cold redundancy signal of ‘2.3V’ corresponding to the activation threshold voltage level of a first secondary primary supply of the network device. Thus, the process 1000 may determine that the received cold redundancy signal indicates a change in the activity state for the first secondary power supply.

In still additional embodiments, the process 1000 may modify the activity state based on the activity state signal change. The process 1000 may modify the activity state of the first secondary power supply from a sleep state to an active state. However, if the process 1000 does not detect any change in the activity state signal, the process 1000 may continue to monitor the existing communication line (block 1030).

Although a specific embodiment depicting modifying an activity state of one or more power supplies suitable for carrying out the various steps, processes, methods, and operations described herein is discussed with respect to FIG. 10, any of a variety of systems and/or processes may be utilized in accordance with embodiments of the disclosure. In yet more embodiments, the communication line may be an I-share line carrying the I-share signal. The elements depicted in FIG. 9 may also be interchangeable with other elements of FIGS. 1-9 and 11-12 as required to realize a particularly desired embodiment.

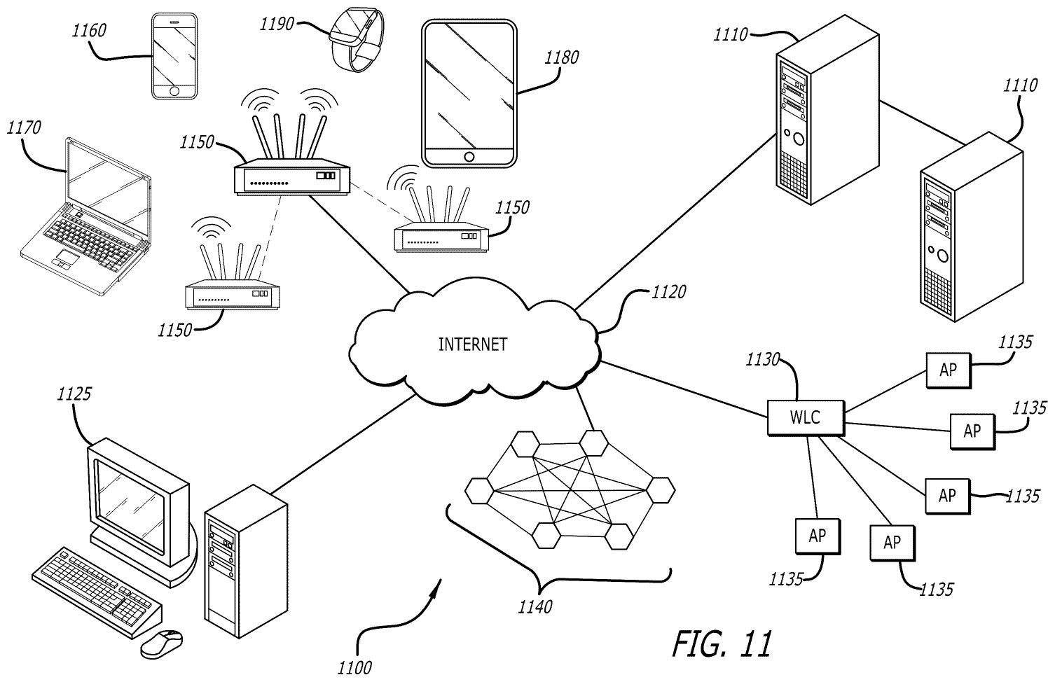

Referring to FIG. 11, a conceptual network diagram 1100 of various environments that a networking logic may operate on a plurality of network devices in accordance with various embodiments of the disclosure is shown. Those skilled in the art will recognize that the networking logic can include various hardware and/or software deployments and can be configured in a variety of ways. In many embodiments, the networking logic can be configured as a standalone device, exist as a logic in another network device, be distributed among various network devices operating in tandem, or remotely operated as part of a cloud-based network management tool. In further embodiments, one or more servers 1110 can be configured with the networking logic or can otherwise operate as the networking logic. In many embodiments, the networking logic may operate on one or more servers 1110 connected to a communication network 1120 (shown as the “Internet”). The communication network 1120 can include wired networks or wireless networks. The networking logic can be provided as a cloud-based service that can service remote networks, such as, but not limited to a deployed network 1140.

However, in additional embodiments, the networking logic may be operated as a distributed logic across multiple network devices. In the embodiment depicted in FIG. 11, a plurality of network access points (APs) 1150 can operate as the networking logic in a distributed manner or may have one specific device operate as the networking logic for all of the neighboring or sibling APs 1150. The APs 1150 may facilitate Wi-Fi connections for various electronic devices, such as but not limited to, mobile computing devices including laptop computers 1170, cellular phones 1160, portable tablet computers 1180 and wearable computing devices 1190.

In further embodiments, the networking logic may be integrated within another network device. In the embodiment depicted in FIG. 11, a wireless LAN controller (WLC) 1130 may have an integrated networking logic that the WLC 1130 can utilize to monitor or control power consumption of the APs 1135 that the WLC 1130 is connected to, either wired or wirelessly. In still more embodiments, a personal computer 1125 may be utilized to access and/or manage various aspects of the networking logic, either remotely or within the network itself. In the embodiment depicted in FIG. 11, the personal computer 1125 communicates over the communication network 1120 and can access the networking logic of the servers 1110, or the network APs 1150, or the WLC 1130. In still more embodiments, the WLC 1130 may be capable of monitoring network traffic flowing across the network.

Although a specific embodiment for various environments that the networking logic may operate on a plurality of network devices suitable for carrying out the various steps, processes, methods, and operations described herein is discussed with respect to FIG. 11, any of a variety of systems and/or processes may be utilized in accordance with embodiments of the disclosure. In many non-limiting examples, the networking logic may be provided as a device or software separate from the WLC 1130 or the networking logic may be integrated into the WLC 1130. The elements depicted in FIG. 11 may also be interchangeable with other elements of FIGS. 1-10 and 12 and as required to realize a particularly desired embodiment.

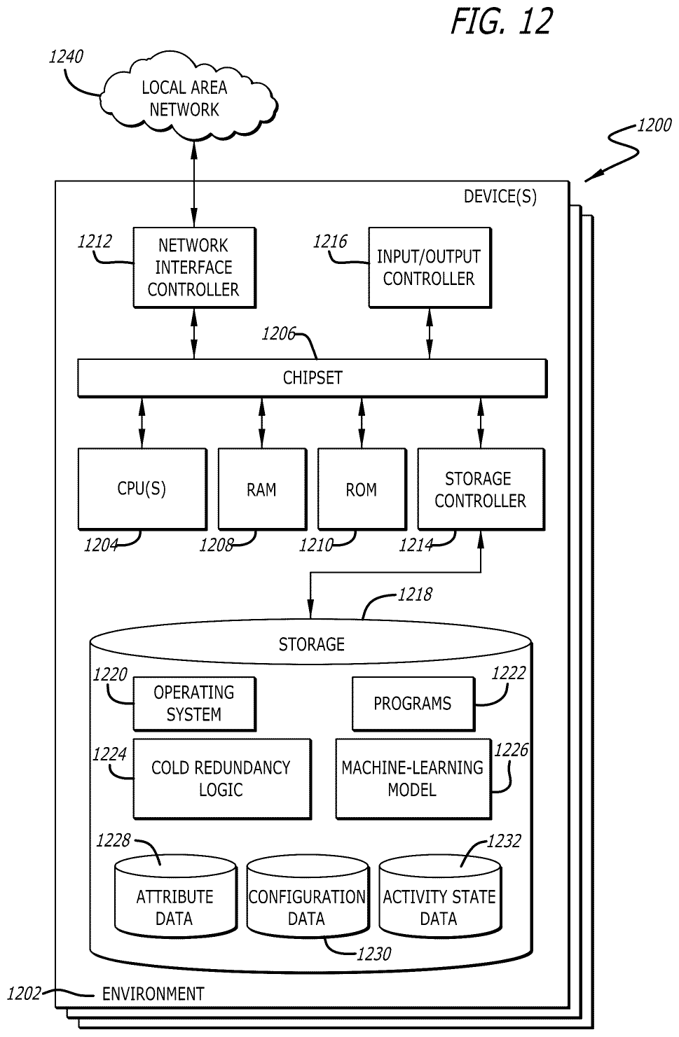

Referring to FIG. 12, a conceptual block diagram for one or more devices 1200 capable of executing components and logic for implementing the functionality and embodiments described above is shown. The embodiment of the conceptual block diagram depicted in FIG. 12 can illustrate a conventional server computer, workstation, desktop computer, laptop, tablet, network appliance, e-reader, smartphone, or other computing device, and can be utilized to execute any of the application and/or logic components presented herein. The device 1200 may, in some examples, correspond to physical devices or to virtual resources described herein.

In many embodiments, the device 1200 may include an environment 1202 such as a baseboard or “motherboard,” in physical embodiments that can be configured as a printed circuit board with a multitude of components or devices connected by way of a system bus or other electrical communication paths. Conceptually, in virtualized embodiments, the environment 1202 may be a virtual environment that encompasses and executes the remaining components and resources of the device 1200. In more embodiments, one or more processors 1204, such as, but not limited to, central processing units (“CPUs”) can be configured to operate in conjunction with a chipset 1206. The processor(s) 1204 can be standard programmable CPUs that perform arithmetic and logical operations necessary for the operation of the device 1200.

In additional embodiments, the processor(s) 1204 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In certain embodiments, the chipset 1206 may provide an interface between the processor(s) 1204 and the remainder of the components and devices within the environment 1202. The chipset 1206 can provide an interface to a random-access memory (“RAM”) 1208, which can be used as the main memory in the device 1200 in some embodiments. The chipset 1206 can further be configured to provide an interface to a computer-readable storage medium such as a read-only memory (“ROM”) 1210 or non-volatile RAM (“NVRAM”) 1208 for storing basic routines that can help with various tasks such as, but not limited to, starting up the device 1200 and/or transferring information between the various components and devices. The ROM 1210 or NVRAM 1208 can also store other application components necessary for the operation of the device 1200 in accordance with various embodiments described herein.

Different embodiments of the device 1200 can be configured to operate in a networked environment using logical connections to remote computing devices and computer systems through a network, such as the network 1240. The chipset 1206 can include functionality for providing network connectivity through a network interface card (“NIC”) 1212, which may comprise a gigabit Ethernet adapter or similar component. The NIC 1212 can be capable of connecting the device 1200 to other devices over the network 1240. It is contemplated that multiple NICs 1212 may be present in the device 1200, connecting the device to other types of networks and remote systems.

In further embodiments, the device 1200 can be connected to a storage 1218 that provides non-volatile storage for data accessible by the device 1200. The storage 1218 can, for example, store an operating system 1220, applications 1222, and data 1228, 1230, 1232, which are described in greater detail below. The storage 1218 can be connected to the environment 1202 through a storage controller 1214 connected to the chipset 1206. In certain embodiments, the storage 1218 can consist of one or more physical storage units. The storage controller 1214 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1200 can store data within the storage 1218 by transforming the physical state of the physical storage units to reflect the information being stored. The specific transformation of physical state can depend on various factors. Examples of such factors can include, but are not limited to, the technology used to implement the physical storage units, whether the storage 1218 is characterized as primary or secondary storage, and the like.

For example, the device 1200 can store information within the storage 1218 by issuing instructions through the storage controller 1214 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1200 can further read or access information from the storage 1218 by detecting the physical states or characteristics of one or more particular locations within the physical storage units.

In addition to the storage 1218 described above, the device 1200 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1200. In some examples, the operations performed by a cloud computing network, and or any components included therein, may be supported by one or more devices similar to device 1200. Stated otherwise, some or all of the operations performed by the cloud computing network, and or any components included therein, may be performed by one or more devices 1200 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1218 can store an operating system 1220 utilized to control the operation of the device 1200. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1218 can store other system or application programs and data utilized by the device 1200.

In various embodiment, the storage 1218 or other computer-readable storage media is encoded with computer-executable instructions which, when loaded into the device 1200, may transform it from a general-purpose computing system into a special-purpose computer capable of implementing the embodiments described herein. These computer-executable instructions may be stored as application 1222 and transform the device 1200 by specifying how the processor(s) 1204 can transition between states, as described above. In some embodiments, the device 1200 has access to computer-readable storage media storing computer-executable instructions which, when executed by the device 1200, perform the various processes described above with regard to FIGS. 1-11. In more embodiments, the device 1200 can also include computer-readable storage media having instructions stored thereupon for performing any of the other computer-implemented operations described herein.

In still further embodiments, the device 1200 can also include one or more input/output controllers 1216 for receiving and processing input from a number of input devices, such as a keyboard, a mouse, a touchpad, a touch screen, an electronic stylus, or other type of input device. Similarly, an input/output controller 1216 can be configured to provide output to a display, such as a computer monitor, a flat panel display, a digital projector, a printer, or other type of output device. Those skilled in the art will recognize that the device 1200 might not include all of the components shown in FIG. 12, and can include other components that are not explicitly shown in FIG. 12, or might utilize an architecture completely different than that shown in FIG. 12.

As described above, the device 1200 may support a virtualization layer, such as one or more virtual resources executing on the device 1200. In some examples, the virtualization layer may be supported by a hypervisor that provides one or more virtual machines running on the device 1200 to perform functions described herein. The virtualization layer may generally support a virtual resource that performs at least a portion of the techniques described herein.

In many embodiments, the device 1200 can include a cold redundancy logic 1224 that can be configured to perform one or more of the various steps, processes, operations, and/or other methods that are described above. Often, the cold redundancy logic 1224 can be a set of instructions stored within a non-volatile memory that, when executed by the processor(s)/controller(s) 1204 can carry out these steps, etc. In some embodiments, the cold redundancy logic 1224 may be a client application that resides on a network-connected device, such as, but not limited to, a server, switch, a router, personal or mobile computing device, an access point (AP).

In several embodiments, the cold redundancy logic 1224 can enable the device 1200 (for example, a router) to manage a plurality of power supplies of the device 1200. The cold redundancy logic 1224 may manage the redundancy between the plurality of power supplies. The cold redundancy logic 1224 may be configured to select a primary power supply from among the plurality of power supplies and the remaining power supplies as a plurality of redundant power supplies. Further, the cold redundancy logic 1224 may be configured to generate a ranking for each of the plurality of redundant power supplies.

In a number of embodiments, the storage 1218 can include attribute data 1228. In some embodiments, the attribute data 1228 may include information regarding various parameters of each of the plurality of power supplies. The attribute data 1228 may include parameters such as a power factor, phase, efficiency, or a current load associated with each of the plurality of power supplies. The attribute data 1228 may also include information regarding the placement of each of the plurality of power supplies within the device 1200.

In various embodiments, the storage 1218 can include configuration data 1230. The configuration data 1230 can comprise information regarding activation threshold voltage levels of each of the plurality of power supplies. For example, for the primary PSU, the activation threshold voltage level may be ‘3V’, for the first secondary PSU as ‘2.3V’, the second secondary PSU ‘1.6V’, and so on. The configuration data 1230 may also include information such as current rating, voltage rating, thermal rating, or the like for each of the plurality of power supplies.

In still more embodiments, the storage 1218 can include activity state data 1232. The activity state data 1232 may comprise information regarding the activity state for each of the plurality of power supplies. The activity state data 1232 may indicate the activity state as a sleep state, an active state, or a standby state. The activity state data 1232 may store information regarding the activity state for each of the plurality of power supplies at a particular time.

Finally, in many embodiments, data may be processed into a format usable by a machine-learning model 1226 (e.g., feature vectors), and or other pre-processing techniques. The machine-learning (“ML”) model 1226 may be any type of ML model, such as supervised models, reinforcement models, and/or unsupervised models. The ML model 1226 may include one or more of linear regression models, logistic regression models, decision trees, Naïve Bayes models, neural networks, k-means cluster models, random forest models, and/or other types of ML models 1226. The ML model 1226 may be configured to learn roaming pattern of user devices and generate prediction as to when a user device would roam and what would be a potential trajectory of the moving user device. In some embodiments, a predictive roaming logic may be implemented by utilizing the ML model 1226.

The ML model(s) 1226 can be configured to generate inferences to make predictions or draw conclusions from data. An inference can be considered the output of a process of applying a model to new data. This can occur by learning from infrastructure data, sustainability data, and/or health data and utilize that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1226 may be generated by human/administrator verifications or may compare predicted outcomes with actual outcomes.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A power supply, comprising:
a processor;
a communication line communicatively coupled to a plurality of redundant power supplies;
a plurality of components configured to provide power to a device;
a memory, wherein the memory comprises a cold redundancy logic, configured to direct the power supply to:
gather a plurality of input factors;
generate a ranking for each of the plurality of redundant power supplies;
assign the ranking to each of the plurality of redundant power supplies; and
transmit a change in activity state to at least one of the plurality of redundant power supplies via the communication line.

2. The power supply of claim 1, wherein the plurality of input factors includes attribute data associated with the plurality of redundant power supplies.

3. The power supply of claim 2, wherein the attribute data includes at least one of: a power factor, phase, efficiency, or a current load.

4. The power supply of claim 3, wherein the ranking is generated based on the plurality of input factors.

5. The power supply of claim 4, wherein the ranking is configured to associate a more efficient power supply with a higher ranking.

6. The power supply of claim 1, wherein the ranking is assigned via the communication line.

7. The power supply of claim 6, wherein the communication line is utilized for load balancing between the power supply and the plurality of redundant power supplies.

8. The power supply of claim 7, wherein the communication line is an I-share line.

9. The power supply of claim 1, wherein, prior to transmission, the cold redundancy logic is further configured to monitor the device.

10. The power supply of claim 9, wherein, prior to transmission, the cold redundancy logic is further configured to determine that a change in activity state is needed based on the monitoring.

11. The power supply of claim 10, wherein, prior to transmission, the cold redundancy logic is further configured to format the change in activity state.

12. The power supply of claim 11, wherein, the communication line is utilized to transmit a lower-frequency signal between the power supply and the plurality of redundant power supplies.

13. The power supply of claim 12, wherein the formatting comprises generating a higher-frequency signal compared to the lower-frequency signal, such that the higher-frequency signal can be received by the plurality of redundant power supplies through a high-pass filter applied to the communication line.

14. The power supply of claim 1, wherein the activity state includes an active state.

15. The power supply of claim 1, wherein the activity state includes a sleep state.

16. A power supply, comprising:
a processor;
a communication line communicatively coupled to a plurality of additional power supplies within a power supply system;
a plurality of components configured to provide power to a device; and
a memory, wherein the memory comprises a cold redundancy logic, configured to direct the power supply to:
receive a ranking from one of the plurality of additional power supplies;
modify an activity state based on the ranking;
monitor a signal received via the communication line;
receive a change in activity state signal; and
change a current activity state of the power supply.

17. The power supply of claim 16, wherein the ranking comprises configuration data.

18. The power supply of claim 17, wherein the change in activity state signal is received via the communication line.

19. The power supply of claim 18, wherein a high-pass filter is applied to the communication line for receiving the change in activity state signal.

20. A method of managing power supplies, comprising:
gathering a plurality of input factors associated with one or more redundant power supplies;
generating a ranking for each of the one or more redundant power supplies;
assigning the ranking to each of the one or more redundant power supplies via a communication line coupled to each of the one or more redundant power supplies; and
transmitting a change in activity state to at least one of the one or more redundant power supplies via the communication line.
